(19) United States
(12) Patent Application Publication
(10) Pub. No.: US 2005/0013438 A1
(43) Pub. Date: Jan. 20, 2005

(54) Method for ciphering a compressed audio or video stream preserving the coding syntax

(75) Inventor: Jean Nicolai, Chateauneuf Le Rouge (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.A., Montrouge (FR)

(21) Appl. No.: 10/892,889

(22) Filed: Jul. 15, 2004

(30) Foreign Application Priority Data
Jul. 16, 2003 (FR) 03/08642

(51) Int. Cl. H04L 9/00

(52) U.S. Cl. 380/268

(57) ABSTRACT

A method ciphers a standardized stream of data coded by a table of codewords of different lengths, wherein at least one part of the bits is ciphered which are such that, after randomly changing their value(s) and after replacing bit by bit in the codeword to be ciphered the non-ciphered bits with the ciphered bits, a codeword of the table of codewords is obtained.

### BACKGROUND OF THE INVENTION

1. Field of the Invention

The present invention relates to a method for processing compressed data, and to apparatus and media for its implementation.

The technical field of the present invention is the manufacturing of audio and/or video data encoders.

The present invention relates more particularly to a method for selectively (partially) ciphering audio or video data by a block, block chaining, or stream cipher algorithm, the data being compressed and organized according to a standardized format, and comprising codewords of variable length.

2. Description of the Related Art

Today, the secured distribution of video documents is limited to the broadcasting of “pay-as-you-go” cable or satellite television; the security is provided by “proprietary” cipher systems, which are defined, implemented and controlled by a single provider: the broadcaster.

The new standards of low-rate video, broadband Internet and wireless-network handheld terminals, of 3G telephone or personal assistant type, should soon enable the distribution of video documents: teleconferencing, multimedia messages, film trailers, live sporting events and video on demand, in particular.

Some security requirements are emerging which cannot be met by the current solutions. The requirements are as follows:
a—the syntax of the ciphered stream must remain as compliant as possible with the coding standard, in order to facilitate the transport by network; the method for processing data must provide transparency to the transcoding and to the changes in data rates, as well as transparency to the routers and servers for reasons of confidence; the method must enable random access and other video processing without deciphering the complete stream, and must enable the transport by protocols provided for standard video;
b—the compression efficiency must not be reduced as a result of the securement of the data by cipher;
c—the securement must be compatible with various tools provided for by the video data compression standards (MPEG4, H264), particularly the resistance to errors, for wireless transmission and the losses of IP (Internet Protocol) packets, as well as the multi-level coding, for heterogeneous bandwidth client terminals;
d—the security and backward masking level must be adapted to the application: robustness to video-specific attacks;
e—the required computing power must remain compatible with embedded terminals, for applications like the wireless streaming of multimedia documents for example.

According to the MPEG standard, a video sequence is made up of a series of groups of images, each image group comprising a series of images of type I (intrinsic), P (predicted) and B (bi-directional); each type-I image is split into macroblocks; each macroblock is converted into four luminance blocks and into two chrominance blocks, this conversion resulting in a first loss of information.

Each 64-pixel block is converted into a 64-coefficient table by a DCT (“discrete cosine transform”); this table is compressed by quantization and then ordered and coded (“zig-zag ordering” and “run-length coding”) according to the number of zero-value coefficients encountered during a zig-zag scan of the table; the resulting compressed data are coded into words of variable length (“Huffman coding”); these transformations also result in a loss of information.

Various methods for ciphering a standardized video data stream—particularly an MPEG-standard stream—have been proposed in order to meet some of the aforementioned requirements.

When a codeword that is part of a table of codewords of different lengths is entirely ciphered, the result is generally a codeword which does not belong to this table (“non-compliant” word); consequently, a decoder that analyses the codewords bit by bit and makes decisions at each bit, will not be able to recognize the boundary of the ciphered codeword, will “get confused” and will no longer know which data field it is analyzing; this disadvantage results from the fact that the codewords are of variable length.

The document “A Fast Mpeg Video Encryption Algorithm”, Changgui Shi et al, ACM Multimedia 98, describes a method for ciphering MPEG-compressed video data, by a secret key; the sign bits of the Huffman coefficients (AC and DC)—which are codewords of variable length—are “XORed” bit by bit with a key of determined length (i.e. combined bit by bit with the bits of the key by means of XOR logic gates, i.e. “exclusive OR” gates), and are respectively replaced—in the video data stream—with the bit value resulting from this operation; this document proposes using one or several long key(s); a 128-bit key is used as an example.

According to this document, only the sign bits of the codewords are ciphered, and only for the codewords that represent useful data (motion vectors and DCT coefficients representing the texture), which results in a compliant codeword. If the codewords representing something else were ciphered, like the number of coded blocks for example, even if compliant codewords were obtained after ciphering, the decoder would be lost.

This selective cipher method, which operates on a small part of the data stream, requires fewer computing resources than those required by the methods for fully ciphering the stream; on the other hand, the darkening of the ciphered images is relatively low.

According to the aforementioned Changgui Shi et. al document, sync points, which are added to the data stream, enable a decoder that has the key to know which position in the ciphered stream it must start using the deciphering key from again; these sync points are added at the start of each image group, at the start of each type-I image or at the start of a predetermined number of images.

According to schedule E to the ISO standard 14496-2, in a “video packet resynchronization” mode, a periodic synchronization marker can be created at the end of a macroblock when the number of bits since the previous marker is higher than a certain threshold; a video packet (part of the stream between two successive markers) therefore has a variable number of macroblocks.

When the data stream is partially ciphered with a block cipher algorithm, like the DES (64-bit block) and a fortiori the AES (128 bits) standards for example, the number of data bits to be ciphered inside this video packet can be lower than the number of bits of the cipher block, in particular when the packet contains the motion vectors associated with the P and B-type images; in this case, this packet will be transmitted without ciphering, and the darkening of the sequence will be reduced.

The U.S. Pat. No. 6,505,299-B1 (Zeng et. al) describes different methods for ciphering quantized (partially compressed) video data before their coding by Huffman tables, by RLE encoding, arithmetic coding or other entropy coding: a spatial frequency transform is applied to the image, which generates a map of transform coefficients; these coefficients are then ciphered, either by scrambling their sign bits, by scrambling their least significant bits, by mixing blocks of the map, or by mixing coefficients corresponding to a spatial frequency band of the map.

This document further proposes ciphering the motion vectors of the P and B-type images; this increases the darkening of the ciphered images.

A disadvantage of these cipher methods is that they reduce the efficiency of the data compression obtained by quantization; another disadvantage is that they require computing means that are more significant than those required for a cipher after Huffman coding or equivalent.

Furthermore, the patent application US-2002/0018565 (Luttrell et. al) proposed a method for selectively ciphering an MPEG4 data stream that preserves the coding syntax; according to this method, the indexes (of fixed length equal to n) of a table of 2ⁿ words of variable length are ciphered, and for each index of the table, the word (in plain text) corresponding to this index is replaced with the word (in plain text) corresponding to the ciphered index; this method does not enable the relation of the table in plain text between the length of a codeword and the frequency of occurrence of the corresponding symbol in a data stream to be kept; consequently, it reduces the data compression by coding using the ciphered table.

### BRIEF SUMMARY OF THE INVENTION

An embodiment of the present invention proposes an improved method for ciphering a standardized stream of compressed data.

The method—at least in part —overcomes the disadvantages of the known methods for ciphering compressed audio and video data streams.

In the present application, the terms and expressions “coded word”, “code word” and “codeword” are used indifferently to designate a word of a table of words of different lengths.

According to a first embodiment, the present invention proposes a method for ciphering codewords of a table of codewords that do not all have the same length, wherein, preferably for each codeword of the table, at least one part of the bits is ciphered—and preferably all the bits—which is/are such that, after randomly changing their value(s) and after replacing bit by bit in the codeword to be ciphered the non-ciphered bits with the ciphered bits, a second codeword of the codeword table is obtained; the length of the codeword is thus invariant during this cipher.

In another embodiment of a cipher method according to the present invention, the codewords of at least one group of several codewords (and preferably of all the groups of several codewords) of the table that have the same length are mixed (swapped).

According to a preferred embodiment of the present invention, an index for identifying each codeword in the table is added to the table of codewords of different lengths, as well as at least one parameter which defines, for each codeword in the table, the number—and possibly the position in the codeword—of the bit(s) to be ciphered.

To cipher a series of codewords of a data stream, the number and the position of the bits to be ciphered in the word are determined for each codeword, using this table; the bit(s) to be ciphered is/are extracted from the word and is/are placed in a buffer by concatenating in this buffer the bits to be ciphered that have been extracted from the codewords of the series of the codewords; if a block cipher algorithm is used (AES or DES for example), a buffer the dimension of which preferably corresponds to that of the cipher block is therefore filled with bits to be ciphered; when this buffer is full, the string of bits present in the buffer is ciphered and each of the ciphered bits is put back at the place it respectively occupied before ciphering in the corresponding codeword of the series of codewords; thus, after ciphering, a data stream complying with the compression standard is obtained.

To decipher a series of so-ciphered codewords, the opposite operations are carried out: the ciphered bits are extracted from each word of the stream and are placed in a buffer the dimension of which is that of the cipher block; when this buffer is full, the series of bits that it contains is deciphered, then each extracted, ciphered bit is replaced in the stream respectively with the deciphered bit that has the same position in the buffer; the buffer is then emptied before processing the following words in the same way.

According to another embodiment, the present invention proposes a computer-readable medium on which a program code is saved that implements the operations defined above, to enable the computer to cipher a stream of compressed data, or conversely to decipher a stream of compressed data ciphered according to the present invention.

The present invention enables streams of data coded with unsigned code words of variable length to be ciphered, while preserving the coding syntax of the stream.

In the case of tables of signed codewords, the present invention also enables a more complete data scrambling to be obtained (particularly images or sounds), compared to the methods that only cipher the sign bit.

The present invention applies in particular to methods using a 64-bit, 128-bit, 192-bit, or 256-bit block cipher algorithm to cipher one or more bit(s) of the motion vector data of P and B-type images according to the MPEG4 standard, and to selectively cipher bits of texture data of images, of blocks and/or macroblocks of images.

According to another embodiment, the present invention proposes an encoder (or a decoder) of formatted and compressed audio or video data, which comprises:
a table of codewords of different lengths, the table comprising, for each-word, an index and a parameter defining the bits of the word to be (de)ciphered,
a buffer provided for temporarily receiving the selected data bits with a view to their (de)ciphering,
block (de)cipher means capable of (de)ciphering the bits stored in the buffer,
means for activating the block (de)cipher means, to cause the (de)ciphering of the bits stored in the buffer when the buffer is full, to replace the bits selected in the data stream with the bits stored and (de)ciphered, and to empty the buffer,
the size of the buffer preferably being equal to the number of bits of a block of the block (de)cipher means (or equal to a whole multiple of this number).

### BRIEF DESCRIPTION OF THE SEVERAL VIEWS OF THE DRAWINGS

Other features and advantages of the present invention are explained in the following description, that refers to the appended drawings and that shows without limitation preferred embodiments and examples of embodiments of the present invention.

FIGS. 1a and 1b represent a table used according to the present invention, which incorporates table B-12 of schedule B to the MPEG4 standard (ISO 14496-2) as well as a column of indexes respectively associated with each word, and a column of parameters indicating the number of cipherable bits of each word.

FIG. 2 is a diagram showing the cipher of a series of words of a data stream, using the table in FIGS. 1a and 1b.

FIG. 3 is a diagram showing the decipher of a series of words of a data stream ciphered according to the method shown in FIG. 2.

FIG. 4 is a computer system for implementing one embodiment of the present invention.

### DETAILED DESCRIPTION OF THE INVENTION

According to one embodiment of the present invention, the method for ciphering an MPEG4 stream or other compressed stream using variable length codes (codewords), is such that the ciphered stream complies with the standard (MPEG4 or other), due to the fact that the ciphered codewords are valid codewords (compliant with the standard) coming from the same table of codes.

Therefore, all the bits of the codeword are ciphered that are such that, after randomly changing their value, the new codeword is still valid, i.e. it is still part of the same table; and preferably only bits of codewords representing useful data (motion vectors and DCT coefficients of texture) are ciphered.

The embodiment has several advantages compared to the cipher of sign bits only:
a more significant visual darkening is obtained;
the resistance of the ciphered stream to attacks is better, thanks to a greater number of ciphered bits;
as the number of modified bits is greater, the number of bits to be ciphered that are transferred into the buffer corresponding to the dimension of a block (128 in the case of the AES) of a block cipher algorithm, is reached after a lesser number of words; thus, two consecutive synchronization markers can be brought closer together, when a method for inserting markers is used in which a synchronization marker is only inserted into the compressed data stream after the number of ciphered bits has reached or exceeded the number of bits of the cipher block.

In this case, preferably, the total number of bits of the data stream that have elapsed since the previous synchronization marker is counted, and a new synchronization marker is only inserted after the total number of elapsed bits counted has exceeded a predetermined threshold (N), said threshold being higher than said number of bits of the cipher block.

For the MPEG4 format, the method according to one embodiment of the present invention applies to the following tables of codewords (Cf. IS014496-2 schedule B):
Table B-12: “VLC table for MVD”;
Table B-15: “Differential DC additional codes”;
Table B-16: “VLC Table for Intra Luminance and Chrominance TCOEF”;
Table B-17: “VLC table for Inter Luminance and Chrominance TCOEF”;
Table B-23: “RVLC table for TCOEF”.

As the variable length codes are used in other compression systems such as the AAC audio compression, the method according to the present invention can be applied to the same.

According to a preferred embodiment, to scramble one of these tables of codewords having different lengths, at least one part of a non-zero positive whole number N of cipherable bits of a number M (M=2^{N}) of codewords of identical length—forming a group of codewords—present in the table of codewords is ciphered, these M codewords only differing by the value (0 or 1) of their said cipherable bits; preferably, all the said N cipherable bits of the codewords of the group of M codewords in the table are ciphered.

When the method is applied to the tables B-12 or B16, the cipherable bits are grouped in the right-hand part of the codewords.

Thanks to the fact that the bits grouped in the left-hand part of the codewords are not ciphered, the decoding by sequential reading, from left to right and bit by bit, of a stream of concatenated ciphered codewords is made easier.

The following example concerns table B-12 of codewords for the coding of the motion vectors.

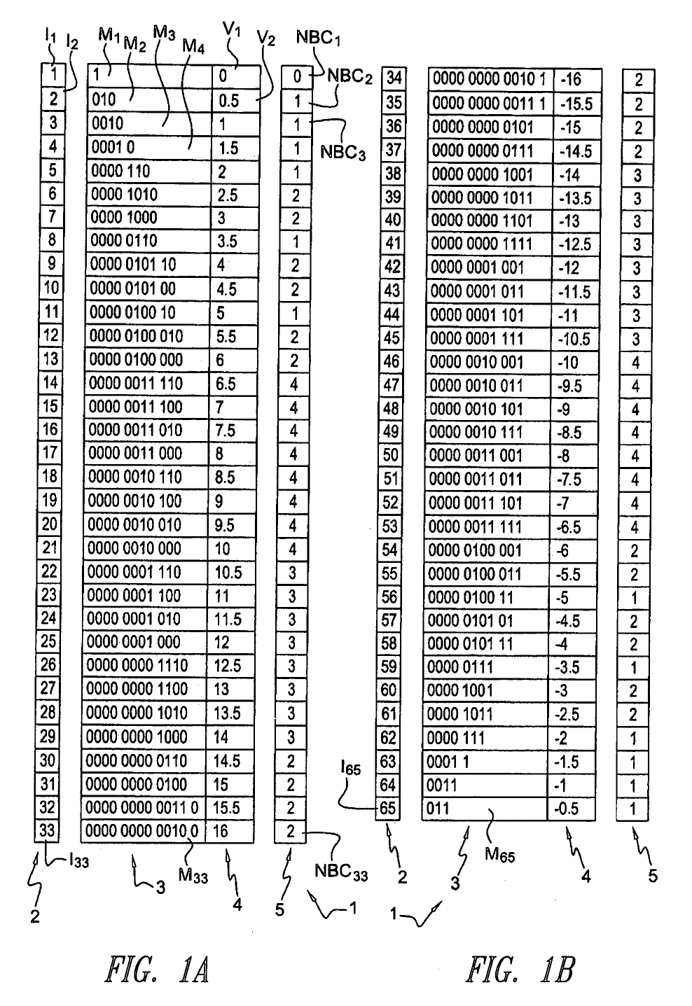

With reference to FIGS. 1a and 1b, table 1 comprises four columns 4, 3, 2, 5 respectively comprising:
values V, in this case motion vector difference values, such as V1 and V2;
codewords M respectively associated with the different values V to be coded, such as M1, M2, M3, M4, M33, M65;
indexes I ranging from 1 to 65, to respectively identify each word M of the table, such as I1, I2, I33, I65;
parameters NBC respectively associated with each word M of the table, such as NBC1, NBC2, NBC3, NBC33, to define the number of bits of the word in question the replacement of which with the complementary bit produces another word of table 1.

It can be seen on this Figure that most of the codewords M of at least eight bits comprise a number NBC of cipherable bits equal to two, three or four; in particular, in the group of the four codewords of thirteen bits, of which the word M33 is part, two bits of each word can be complemented (inverted).

As described above, the cipherable bits of this table are the bits grouped on the right of each codeword; if this is not the case, the table must further contain, for each codeword M, the position information of each cipherable bit of this word.

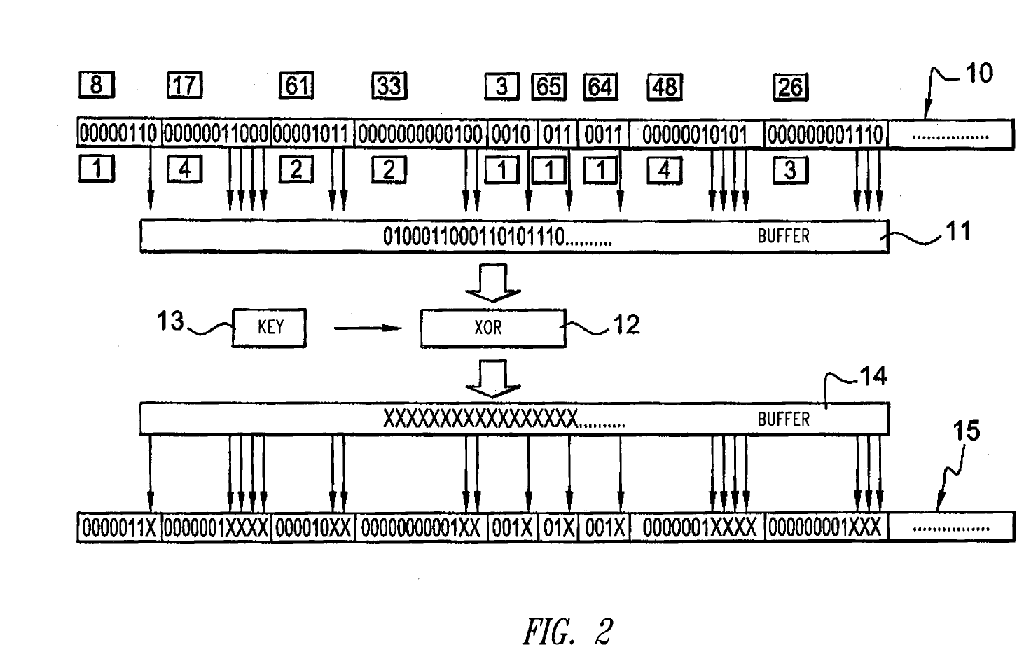

To cipher the series 10 (FIG. 2) of codewords M (M8, M17, M61, M33, etc.), the number NBC (equal to one) of cipherable bits of the 1st word M8 is read: in table 1; the one cipherable bit of the word M8 is transferred into a buffer 11; the operation is repeated for the following words (M17 . . . ) in the stream 10 to be ciphered, and the cipherable bits extracted from these words are gradually concatenated in the buffer 11, until it is full; at this moment, the bits of the buffer 11 are ciphered by presenting them, as well as a cipher key 13 enabling the buffer 11 to be ciphered into a buffer 14 of the same dimension, the bits of which are put back—bit by bit—in the stream of words, at the respective positions of the bits extracted from the stream 10, so as to form a ciphered stream 15.

The key 13 can comprise the same number of bits as the buffer 11; it is then presented, as well as the bits of the buffer 11, at the inputs of exclusive OR (XOR) gates 12; the outputs of these gates comprising the so-ciphered bits are placed in the output buffer 14 and put back bit by bit in the stream of words; alternatively, a key of a different length from that of the buffer 11 can be used to cipher the bits of this buffer.

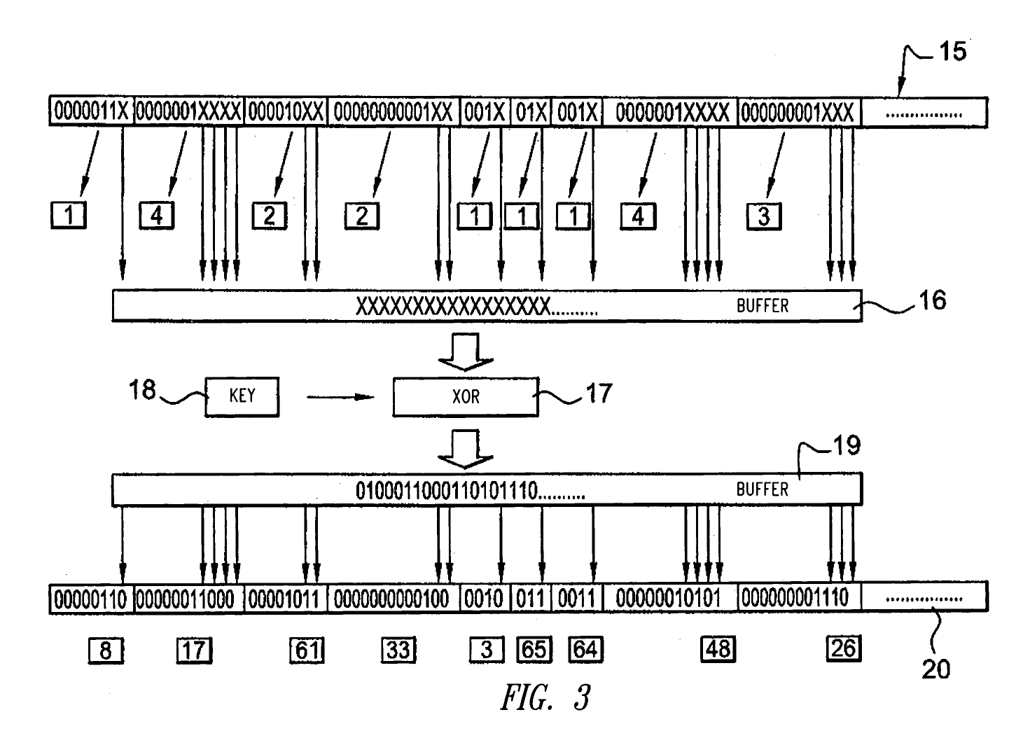

To decipher the series 15 (FIG. 3) of ciphered codewords, the stream is analyzed from left to right; when a codeword is analyzed by an MPEG decoder, a decision is made at each bit; after reading the last non-ciphered bit of a ciphered word, the decoder determines the group of ciphered words of the table corresponding to the non-ciphered bits which have already been read and consequently determines the number of ciphered bits following the last bit “in plain text”; when, for example, the sequence of bits “in plain text” is “000010”, reading table 1 makes it possible to determine that the ciphered word comprises two ciphered bits, which follow these non-ciphered bits.

The processing of these bits is then identical to that used for the cipher: the bits to be deciphered are concatenated in a buffer 16, until it is full; the content of the buffer can be applied bit by bit to the inputs of XOR gates 17 with a key 18 of the same dimension; the deciphered bits at the outputs of the gates are put back in the stream to be deciphered, through a buffer 19, to form a deciphered stream 20.

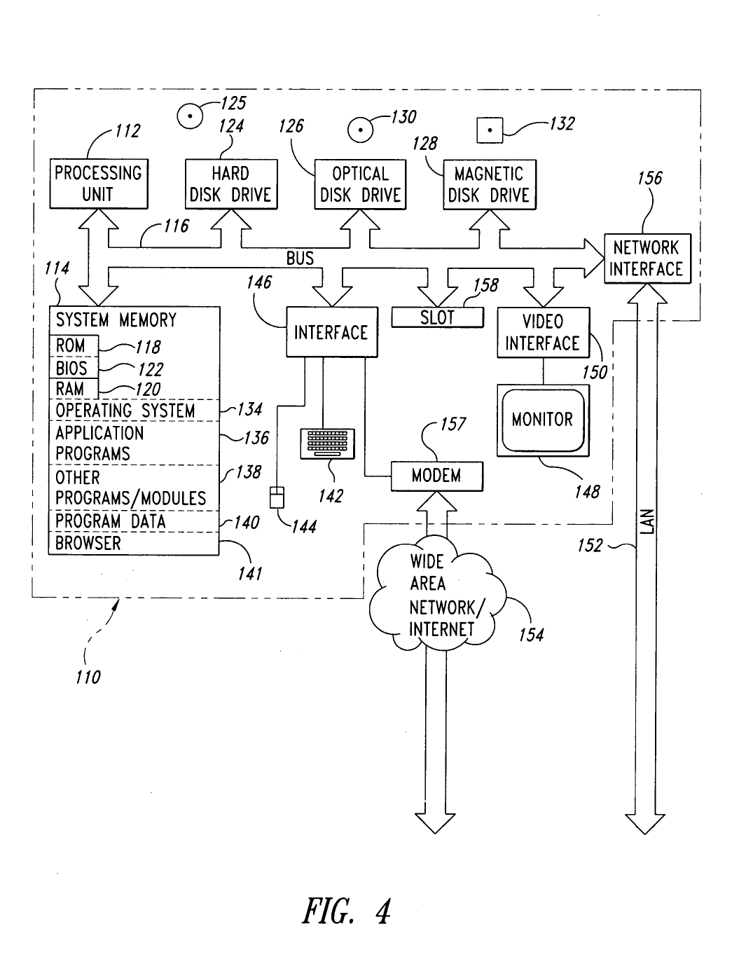

Although the above method is discussed above with regard to specific logic gates and buffers, those skilled in the art will recognize that the method may be implemented in a general purpose computer system. FIG. 4 and the following discussion provide a brief, general description of a suitable computing environment in which the invention may be implemented. Although not required, at least one embodiment of the invention can be implemented in the general context of computer-executable instructions, such as program application modules, objects, or macros being executed by a personal computer. Those skilled in the relevant art will appreciate that the invention can be practiced with other computing system configurations, including handheld devices, multiprocessor systems, microprocessor-based or programmable consumer electronics, network PCs, minicomputers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 4, a personal computer referred to herein as a computing system 110 includes a processor unit 112, a system memory 114 and a system bus 116 that couples various system components including the system memory 114 to the processing unit 112. The processing unit 112 may be any logical processing unit, such as one or more central processing units (CPUs), digital signal processors (DSPs), application-specific integrated circuits (ASIC), etc. Unless described otherwise, the construction and operation of the various blocks shown in FIG. 4 are of conventional design. As a result, such blocks need not be described in further detail herein, as they will be understood by those skilled in the relevant art.

The system bus 116 can employ any known bus structures or architectures, including a memory bus with memory controller, a peripheral bus, and/or a local bus. The system memory 114 includes read-only memory (“ROM”) 118 and random access memory (“RAM”) 120. A basic input/output system (“BIOS”) 122, which can form part of the ROM 118, contains basic routines that help transfer information between elements within the computing system 110, such as during startup.

The computing system 110 also includes one or more spinning media memories such as a hard disk drive 124 for reading from and writing to a hard disk 125, and an optical disk drive 126 and a magnetic disk drive 128 for reading from and writing to removable optical disks 130 and magnetic disks 132, respectively. The optical disk 130 can be a CD-ROM, while the magnetic disk 132 can be a magnetic floppy disk or diskette. The hard disk drive 124, optical disk drive 126 and magnetic disk drive 128 communicate with the processing unit 112 via the bus 116. The hard disk drive 124, optical disk drive 126 and magnetic disk drive 128 may include interfaces or controllers coupled between such drives and the bus 116, as is known by those skilled in the relevant art, for example via an IDE (ie., Integrated Drive Electronics) interface. The drives 124, 126 and 128, and their associated computer-readable media, provide nonvolatile storage of computer-readable instructions, data structures, program modules and other data for the computing system 110. Although the depicted computing system 110 employs hard disk 125, optical disk 130 and magnetic disk 132, those skilled in the relevant art will appreciate that other types of spinning media memory computer-readable media may be employed, such as, digital video disks (“DVD”), Bernoulli cartridges, etc. Those skilled in the relevant art Will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 114, such as an operating system 134, one or more application programs 136, other programs or modules 138, and program data 140. The system memory 114 also includes a browser 141 for permitting the computing system 110 to access and exchange data with sources such as websites of the Internet, corporate intranets, or other networks, as well as other server applications on server computers. The browser 141 is markup language based, such as hypertext markup language (“HTML”), and operate with markup languages that use syntactically delimited characters added to the data of a document to represent the structure of the document.

While shown in FIG. 4 as being stored in the system memory, the operating system 134, application programs 136, other program modules 138, program data 140 and browser 141 can be stored on the hard disk 125 of the hard disk drive 124, the optical disk 130 and the optical disk drive 126 and/or the magnetic disk 132 of the magnetic disk drive 128. A user can enter commands and information to the computing system 110 through input devices such as a keyboard 142 and a pointing device such as a mouse 144. Other input devices can include a microphone, joystick, game pad, scanner, etc. These and other input devices are connected to the processing unit 112 through an interface 146 such as a serial port interface that couples to the bus 116, although other interfaces such as a parallel port, a game port or a universal serial bus (“USB”) can be used. A monitor 148 or other display devices may be coupled to the bus 116 via video interface 150, such as a video adapter. The computing system 110 can include other output devices such as speakers, printers, etc.

The computing system 110 can operate in a networked environment using logical connections to one or more remote computers. The computing system 110 may employ any known means of communications, such as through a local area network (“LAN”) 152 or a wide area network (“WAN”) or the Internet 154. Such networking environments are well known in enterprise-wide computer networks, intranets, and the Internet.

When used in a LAN networking environment, the computing system 110 is connected to the LAN 152 through an adapter or network interface 156 (communicatively linked to the bus 116). When used in a WAN networking environment, the computing system 110 often includes a modem 157 or other device for establishing communications over the WAN/Internet 154. The modem 157 is shown in FIG. 1 as communicatively linked between the interface 146 and the WAN/Internet 154. In a networked environment, program modules, application programs, or data, or portions thereof, can be stored in a server computer (not shown). Those skilled in the relevant art will readily recognize that the network connections shown in FIG. 4 are only some examples of establishing communication links between computers, and other links may be used, including wireless links.

The computing system 110 may include one or more interfaces such as slot 158 to allow the addition of devices either internally or externally to the computing system 110. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/butput (i.e., i/O) and MIDI/joystick connectors, and/or slots for memory.

The term “computer-readable medium” as used herein refers to any medium that participates in providing instructions to processor unit 112 for execution. Such a medium may take many forms, including but not limited to, non-volatile media, volatile media, and transmission media. Non-volatile media includes, for example, hard, optical or magnetic disks 125, 130, 132 respectively. Volatile media includes dynamic memory, such as system memory 114. Transmission media includes coaxial cables, copper wire and fiber optics, including the wires that comprise system bus 116. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor unit 112 for execution. For example, the instructions may initially be carried on a magnetic disk of a remote computer. The remote computer can load the instructions into its dynamic memory and send the instructions over a telephone line using a modem. The modem 157 local to computer system 10 can receive the data on the telephone line and use an infrared transmitter to convert the data to an infrared signal. An infrared detector coupled to the system bus 116 can receive the data carried in the infrared signal and place the data on system bus 116. The system bus 116 carries the data to system memory 114, from which processor unit 112 retrieves and executes the instructions. The instructions received by system memory 114 may optionally be stored on storage device either before or after execution by processor unit 112.

All of the above U.S. patents, U.S. patent application publications, U.S. patent applications, foreign patents, foreign patent applications and non-patent publications referred to in this specification and/or listed in the Application Data Sheet are incorporated herein by reference, in their entireties.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for ciphering a standardized stream of input codewords coded by a table of codewords of different numbers of bits having respective values, the method comprising:
ciphering at least one part of the bits of a selected one of the input codewords by randomly changing the value(s) of the at least one part of the bits to obtain one or more ciphered bits; and
obtaining another codeword of the codeword table by replacing the at least one part of the bits in the selected input codeword with the one or more ciphered bits.

2. The method according to claim 1 determining which of the bits of the selected input codeword can be ciphered by randomly changing their values and result in another codeword of the codeword table, wherein all the bits that are so determined are ciphered by randomly changing their values to obtain the one or more ciphered bits and replaced bit by bit in the selected input codewordwith the one or more ciphered bits.

3. The method according to claim 1 wherein codewords of a group of the codewords of the table having an identical length are swapped.

4. The method according to claim 1 wherein the codewords are not signed.

5. The method according to claim 1 further comprising adding to the table an index for identifying each codeword of the table and adding to the table a parameter defining, for each codeword of the table, the number of bits to be ciphered.

6. The method according to claim 1 further comprising adding to the table an index for identifying each codeword of the table and adding to the table a parameter defining, for each codeword of the table, a number and a position, in the codeword, of one or more bits to be ciphered.

7. The method according to claim 1 further comprising:
determining the number and position of one or more bits to be ciphered in each input codeword, using the table;
extracting the one or more bits to be ciphered from the input codeword and placing the one or more bits into a buffer by concatenating in this buffer the one or more bits to be ciphered that have been extracted from the input codewords of the stream of input codewords; wherein the ciphering step includes ciphering,—when the buffer is full, the bits present in the buffer to obtain the one or more ciphered bits for each input codeword and the obtaining step includes putting the one or more ciphered bits for each input codeword into the positions determined in the determining step.

8. The method according to claim 7 wherein the ciphering steps includes using one of a group of cipher blocks consisting of 64-bit, 128-bit, 192-bit, and 256-bit cipher blocks, and said buffer has a dimension that corresponds to that of the cipher block, and is filled with bits to be ciphered.

9. The method according to claim 1 wherein the input codewords are MPEG-format compressed video data, and wherein the ciphering step includes ciphering bit by bitonly one part of the compressed video data, with an algorithm for ciphering by block of a predetermined number of bits; the method further comprising:
counting the bits ciphered during the ciphering of the compressed video data;
and inserting a synchronization marker into the compressed video data after the ciphered bits counted has exceeded said predetermined number of bits.

10. The method according to claim 9, further comprising counting a total number of bits of the data stream that have elapsed since a previous synchronization marker; and inserting a new synchronization marker only after the total number of elapsed bits counted has exceeded a predetermined threshold that is higher than said predetermined number.

11. The method according to claim 1 wherein the input codewords are data (V) of motion vectors of P and B-type images created according to the MPEG4 standard.

12. The method according to claim 1 wherein the input codewords are texture data of I, P and/or B-type images.

13. A computer-readable medium, on which a compressed stream of ciphered data are stored, the ciphered data enabling a computer device to decipher the ciphered data in response to reading the computer-readable medium, the ciphered data by obtained by a method for ciphering a standardized stream of input codewords coded by a table of codewords of different numbers of bits having respective values, the method comprising:
ciphering at least one part of the bits of a selected one of the input codewords by randomly changing the value(s) of the at least one part of the bits to obtain one or more ciphered bits; and
obtaining another codeword of the codeword table by replacing the at least one part of the bits in the selected input codeword with the one or more ciphered bits.

14. An encoder of compressed and formatted audio or video data that includes a standardized stream of input codewords of different numbers of bits having respective values, the encoder comprising:
a table of codewords of different lengths, the table comprising, for each codeword, an index and a parameter defining bits of the codeword to be ciphered;
means for extracting selected data bits from the input codewords based on the parameter of corresponding codewords of the table;
a buffer provided for temporarily receiving the selected data bits of the input codewords,
block cipher means for ciphering the bits stored in the buffer by randomly changing the values of the bits stored in the buffer to obtain ciphered bits; and
means for activating the block cipher means, to cause the cipher means to cipher the bits stored in the buffer when the buffer is full, for replacing the selected data bits in: the data stream with the ciphered bits to thereby obtain other codewords of the table, and for emptying the buffer.

15. The encoder according to claim 14 wherein the buffer has a size equal to the number of bits of a block of the block cipher means, or equal to a whole multiple of the number of bits of a block of the block cipher means.

16. A computer-readable medium, on which a program code is saved that enables a computer to cipher a compressed data stream of input codewords coded by a table of codewords of different numbers of bits having respective values, according to steps comprising:
ciphering at least one part of the bits of a selected one of the input codewords by randomly changing the value(s) of the at least one part of the bits to obtain one or more ciphered bits; and
obtaining another codeword of the codeword table by replacing the at least one part of the bits in the selected input codeword with the one or more ciphered bits.
